(19) United States
(12) Patent Application Publication
(10) Pub. No.: US 2011/0073583 A1
(43) Pub. Date: Mar. 31, 2011

(54) Soldering Equipment

(76) Inventor: Antang Liu, Shenzhen (CN)

(21) Appl. No.: 12/788,472

(22) Filed: May 27, 2010

(30) Foreign Application Priority Data
Sep. 25, 2009 (CN) 200910190289.7

(51) Int. Cl. H05B 1/00

(52) U.S. Cl. 219/229

(57) ABSTRACT

The present invention involves a soldering equipment, which comprises a soldering station, a soldering iron, and a soldering iron tip surface temperature detecting module; a control system is arranged in the soldering station; the soldering iron tip surface temperature detecting module transmits the detected surface temperature of a soldering iron tip to the control system; after the control system comparing the surface temperature of the soldering iron tip with a set temperature, the control system adjusts the power automatically according to the set temperature to compensate the surface temperature of the soldering iron tip. When the soldering iron tip contacts the correcting temperature sensor of the soldering iron tip surface temperature detecting module, the temperature of the soldering iron tip can be automatically compensated without manual operation. The present invention solves the technical problems of the conventional soldering equipment, of which the usage cost is high and the temperature deviation can not be corrected automatically.

### FIELD OF THE INVENTION

The present invention involves a soldering equipment.

### BACKGROUND OF THE INVENTION

A conventional soldering equipment comprises a soldering station and a soldering iron. A control system is arranged in the soldering station, and a temperature sensor is arranged in the soldering iron core to detect the temperature in the soldering iron core. For the following reasons, the temperature of the soldering iron tip is not exact the required temperature.

1. For different soldering iron tips, the shape (long or short, and thick or thin), the material, the section and length for conducting temperature, or the thermal resistance may be different, so, the temperature may also has a deviation.

2. With the operating time increasing and according to the high or low operating temperature, the material of the soldering iron tip will change, so as to make the thermal resistance change, which will also make a temperature deviation.

3. The distance form the tip of the soldering iron tip to the heating unit is different, which will also make a temperature deviation.

When the soldering iron tip has a temperature deviation, the temperature of the soldering iron tip will be too low or too high. When the temperature of the soldering iron tip is too low, tin not melting or tin melting slowly will occur. If the tin doesn't melt, the phenomenon of rosin joint, false welding, or welding being not strong will occur, which will result in many defective products and potential safety hazards. If the tin melts slowly, the working time will increase, thereby wasting a lot of labour cost and energy cost. Too high temperature will damage the things to be soldered and waste a lot of energy. The things being damaged will waste the material cost. Wasting a lot of energy will increase the energy cost, and it is not environmentally friendly. Furthermore, the following problems occur.

1. When the temperature of the soldering iron tip is too low or too high, the temperature deviation should be corrected. Correcting temperature deviation needs using professional instruments, which will increase the cost.

2. As correcting the temperature deviation, a professional thermometer is required. Then the deviation value should be input manually, or the temperature deviation should be corrected via debugging manually, so, correcting the temperature deviation is very tedious.

3. The temperature deviation of a soldering iron tip will occur everyday. When using multiple soldering irons, the temperature of the soldering irons should be the same, so, the management is very difficult.

A soldering iron tip needs to do temperature deviation correcting frequently, which needs professionals to operate, so, not only the management cost will increase, but also the corrected temperature is not accurate.

### SUMMARY OF THE INVENTION

The present invention provides a soldering equipment, so as to solve the technical problems of the conventional soldering equipment, of which the usage cost is high and the temperature can not be corrected accurately.

To solve the above mentioned technical problems, the present invention provides the following technical solutions.

A soldering equipment comprises a soldering station and a soldering iron; a control system is arranged in the soldering station; the soldering equipment also comprises a soldering iron tip surface temperature detecting module; the soldering iron tip surface temperature detecting module transmits the detected surface temperature of a soldering iron tip to the control system; after the control system comparing the surface temperature of the soldering iron tip with a set temperature, the control system adjusts the power automatically according to the set temperature to compensate the surface temperature of the soldering iron tip.

The temperature detecting module comprises a correcting temperature sensor, and a transfer wire for inputting the temperature signal of the correcting temperature sensor to the control system.

The correcting temperature sensor is arranged at the soldering station.

The soldering equipment also comprises a soldering iron stand, and the correcting temperature sensor is arranged at the soldering iron stand.

The correcting temperature sensor is arranged separately.

In the above mentioned technical solutions, a soldering iron tip surface temperature detecting module is adopted; the soldering iron tip surface temperature detecting module transmits the detected surface temperature of a soldering iron tip to the control system. After the control system comparing the surface temperature of the soldering iron tip with a set temperature, the control system adjusts the power automatically according to the set temperature to compensate the surface temperature of the soldering iron tip. When the soldering iron tip contacts the correcting temperature sensor, the surface temperature of the soldering iron tip can be automatically compensated without manual operation. The present invention solves the technical problems of the conventional soldering equipment, of which the usage cost is high and the temperature deviation can not be corrected automatically.

### BRIEF DESCRIPTION OF THE DRAWINGS

FIG. 1 is a schematic diagram of the temperature correcting principle of the present invention;

FIG. 2 is a structure schematic diagram of the embodiment 1 of the present invention;

FIG. 3 is a structure schematic diagram of the embodiment 2 of the present invention; and

FIG. 4 is a structure schematic diagram of the embodiment 3 of the present invention.

### DESCRIPTION OF THE PREFERRED EMBODIMENT

### Embodiment 1

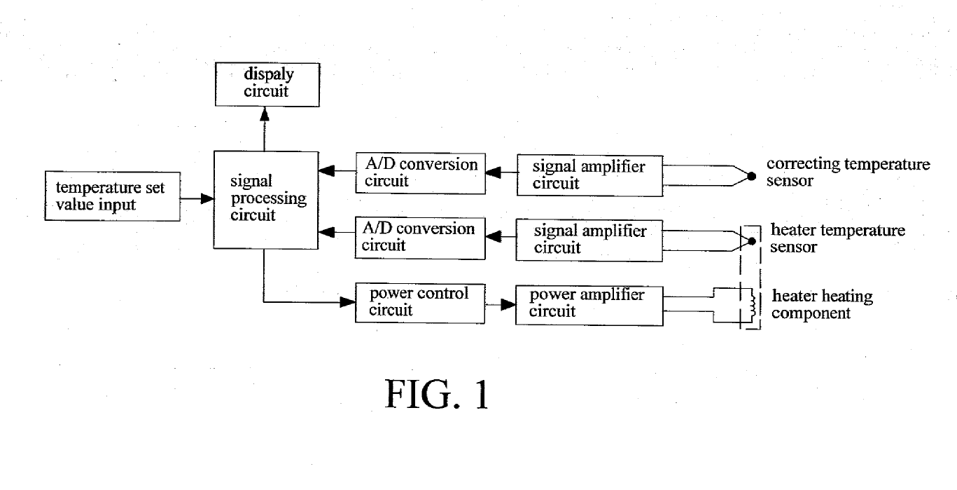

As shown in FIG. 1, the temperature correcting principle of the present invention is as the following.

1. The system measures the real surface temperature T1 of a soldering iron tip at real time via a dedicated soldering iron tip surface temperature detecting module. Obtaining the temperature difference value ΔT between T1 and a set temperature T (ΔT=T−T1), and basing on the temperature difference value, a signal processing circuit compensates and corrects the temperature of the heater by controlling the output power. By ΔT approaching to zero (ΔT→0), the object of temperature correcting is obtained.

2. A signal amplifier circuit amplifies the weak temperature signal, so as to be good for an A/D conversion circuit to process.

3. The A/D conversion circuit converts analog signal to digital signal capable of being processed by a digital circuit.

4. The signal processing circuit changes the power control signal and the display output according to the difference value between the measured soldering iron tip surface temperature and the system set value, thereby finishing temperature correcting.

5. A power control circuit carries out power conversion according to the power control signal of the signal processing circuit, and outputs a power conversion signal to a power amplifier circuit.

6. The power amplifier circuit amplifies the power conversion signal and outputs it to a heater heating component, so as to change the temperature of the heater heating component.

7. A display circuit displays every status displays during the process of temperature correcting.

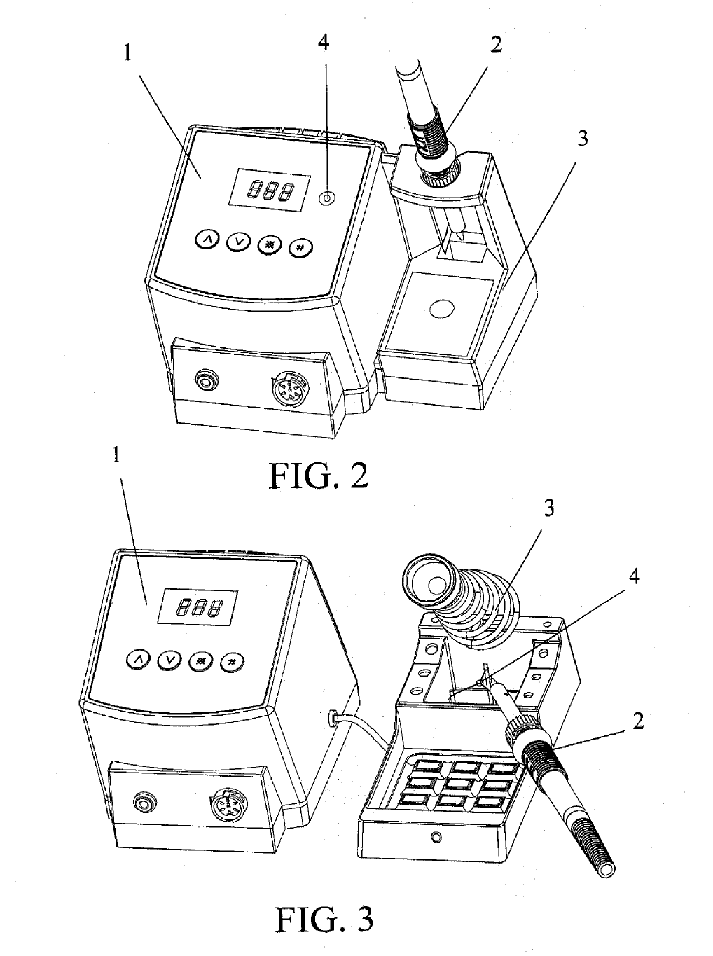

As shown in FIG. 2, the soldering equipment comprises a soldering station 1, a soldering iron 2, a soldering iron stand 3, and a soldering iron tip surface temperature detecting module. A control system is arranged in the soldering station 1, and the soldering iron tip surface temperature detecting module transmits the detected surface temperature of a soldering iron tip to the control system. After the control system compares the surface temperature of the soldering iron tip with the set temperature, it will adjust the power automatically according to the set temperature to compensate the surface temperature of the soldering iron tip. The soldering iron tip surface temperature detecting module comprises a correcting temperature sensor 4, and a transfer wire for inputting the temperature signal of the correcting temperature sensor 4 to the control system. The correcting temperature sensor 4 is arranged at the soldering station 1.

### Embodiment 2

As shown in FIG. 3, the soldering equipment comprises a soldering station 1, a soldering iron 2, a soldering iron stand 3, and a soldering iron tip surface temperature detecting module. A control system is arranged in the soldering station 1, and the soldering iron tip surface temperature detecting module transmits the detected surface temperature of a soldering iron tip to the control system. After the control system compares the surface temperature of the soldering iron tip with the set temperature, it will adjust the power automatically according to the set temperature to compensate the temperature of the soldering iron tip. The soldering iron tip surface temperature detecting module comprises a correcting temperature sensor 4, and a transfer wire for inputting the temperature signal of the correcting temperature sensor 4 to the control system. The correcting temperature sensor 4 is arranged at the soldering iron stand 3. The temperature correcting principle is the same as Embodiment 1.

### Embodiment 3

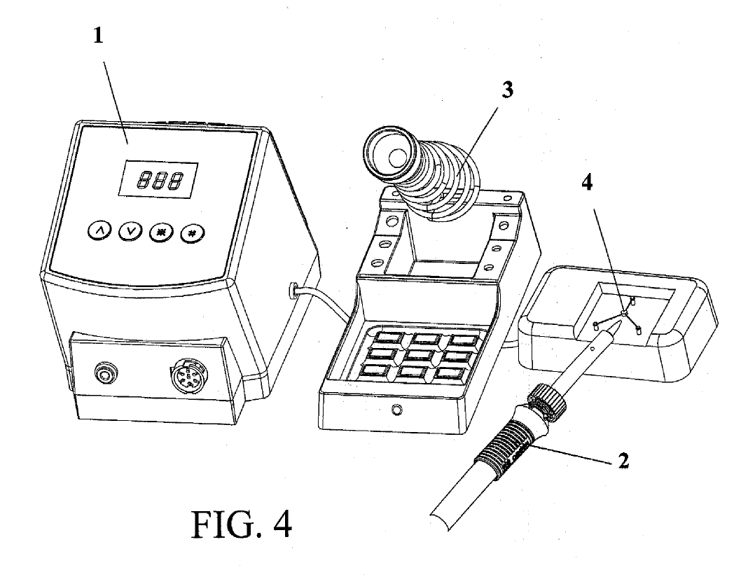

As shown in FIG. 4, the soldering equipment comprises a soldering station 1, a soldering iron 2, a soldering iron stand 3, and a soldering iron tip surface temperature detecting module. A control system is arranged in the soldering station 1, and the soldering iron tip surface temperature detecting module transmits the detected surface temperature of a soldering iron tip to the control system. After the control system compares the surface temperature of the soldering iron tip with the set temperature, it will adjust the power automatically according to the set temperature to compensate the surface temperature of the soldering iron tip. The soldering iron tip surface temperature detecting module comprises a correcting temperature sensor 4, and a transfer wire for inputting the temperature signal of the correcting temperature sensor 4 to the control system. The correcting temperature sensor 4 is arranged separately. The temperature correcting principle is the same as Embodiment 1.

What is claimed is:

1. A soldering equipment comprising a soldering station and a soldering iron; a control system being arranged in the soldering station; the soldering equipment also comprising a soldering iron tip surface temperature detecting module; the soldering iron tip surface temperature detecting module transmitting the detected surface temperature of a soldering iron tip to the control system; after the control system comparing the surface temperature of the soldering iron tip with a set temperature, the control system adjusting the power automatically according to the set temperature to compensate the surface temperature of the soldering iron tip.

2. The soldering equipment of claim 1, wherein the surface temperature detecting module comprises a correcting temperature sensor, and a transfer wire for inputting the temperature signal of the correcting temperature sensor to the control system.

3. The soldering equipment of claim 2, wherein the correcting temperature sensor is arranged at the soldering station.

4. The soldering equipment of claim 2, wherein it also comprises a soldering iron stand, and the correcting temperature sensor is arranged at the soldering iron stand.

5. The soldering equipment of claim 2, wherein the correcting temperature sensor is arranged separately.
